(19) United States
(12) Patent Application Publication
(10) Pub. No.: US 2022/0030165 A1
(43) Pub. Date: Jan. 27, 2022

(54) Lighting Style Detection in Asynchronously Captured Images

(71) Applicant: CANON U.S.A., INC., Melville, NY (US)

(72) Inventors: Bradley Scott Denney, Irvine, CA (US); Yunzhe Zhao, Irvine, CA (US); Stephanie Kwok Suzuki, Irvine, CA (US)

(21) Appl. No.: 17/384,107

(22) Filed: Jul. 23, 2021

Related U.S. Application Data
(60) Provisional application No. 63/056,417, filed on Jul. 24, 2020.
(60) Provisional application No. 63/143,450, filed on Jan. 29, 2021.

(51) Int. Cl. H04N 5/232; H04N 5/235; G06K 9/46

(52) U.S. Cl. CPC H04N 5/23229; G06K 9/4661; H04N 5/2351

(57) ABSTRACT

An apparatus for automatically adjusting a collection of images based on their lighting conditions is provided. The apparatus obtains one or more images, determines a first lighting condition scores for each lighting condition and for each of the one or more images using a trained prediction model, and labels the each of the one or more images based on the determined first lighting condition scores.

### CROSS REFERENCE TO RELATED APPLICATIONS

This application claims priority from U.S. Provisional Application Ser. No. 63/056,417 filed on Jul. 24, 2020 and U.S. Provisional Application Ser. No. 63/143,450 filed on Jan. 29, 2021, both of which are incorporated herein by reference.

### BACKGROUND

### Field

The present disclosure relates generally to processing and analysis of a captured image.

### Description of Related Art

After photos are captured, photographers often perform post-processing of the photos to adjust for various lighting conditions present at the time the image was captured or otherwise acquired. Based on the image content and desired effect, photographers, through photo editing software, often adjust parameters that affect how the image is rendered when displayed on a screen and/or in print.

Currently, there are lighting condition presets than can be defined or purchased that apply a set of image adjustments that are appropriate for various lighting conditions. The user must identify the lighting condition to achieve the stylistic effect, and then apply the corresponding preset adjustments to the photo.

Existing pre-trained classifiers are centered on image content (e.g. identification of people, animals, emotions, etc.). Other work focuses on scene recognition (e.g. Grand Canyon, Eiffel Tower, . . . ) There is some work around style transfer where the goal is to transform an image of one style or type into an image of another style. While most of these operations as object based, a need exists to focus on conditions at the time of image capture. A system and method described herein remedies the above noted drawback.

### SUMMARY

According to one aspect of the disclosure, applications and/or datasets that focus on the identification of lighting conditions with the focus on photo post-capture processing are described. In one embodiment, an apparatus and method for automatically adjusting a collection of images based on their lighting conditions is provided. The apparatus and method obtains one or more images, determines a first lighting condition scores for each lighting condition and for each of the one or more images using a trained prediction model, and labels the each of the one or more images based on the determined first lighting condition scores.

According to another embodiment and apparatus and method are provided that obtains meta-data associated with each of the one or more images, identify sequences of images in the one or more images, generate lighting condition predictions based on a sequence analysis of the first lighting condition scores and the sequences of images and respective associated image meta-data; and labels the each or one or more image based on the lighting condition scores.

The apparatus obtains one or more images, and makes a first lighting condition prediction for each of the one or more images using a trained prediction model and labeling the each of the one or more images based on the predicted first lighting condition.

In another embodiment, the apparatus obtains an associated meta-data of each of the one or more images, identifies sequences of images in the one or more images, and modifies the lighting condition predictions based on a time-series analysis of the first predicted labels and the sequences of images and respective associated image meta-data.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a photo processing system.

FIGS. 2A-2C illustrates algorithms for employed by a lighting condition classifier training system.

FIGS. 3A-3B illustrate algorithms for a label determination system.

FIG. 4 illustrates exemplary images to be processed.

FIG. 5 illustrates an algorithm for converting a collection of photos into a collection of sequence of photos.

FIG. 6 illustrates an algorithm for estimation of transition probabilities.

FIG. 7A illustrates a decision tree for accepting proposals generated in FIG. 6.

FIG. 7B illustrates the estimation of a transition matrix described in FIG. 6.

FIG. 8 illustrates exemplary state transitions.

FIGS. 9A & 9B illustrate labels for a capture device.

FIG. 10 illustrates corrected labels for a capture device.

FIG. 11 is a block diagram illustrating a system for image lighting condition detection.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

The process of identifying lighting conditions for hundreds or thousands of photos can take a significant amount of time and human efforts. According to this disclosure, a system that automates the process of identifying appropriate lighting conditions and automatically applying the appropriate image processing presets is provided.

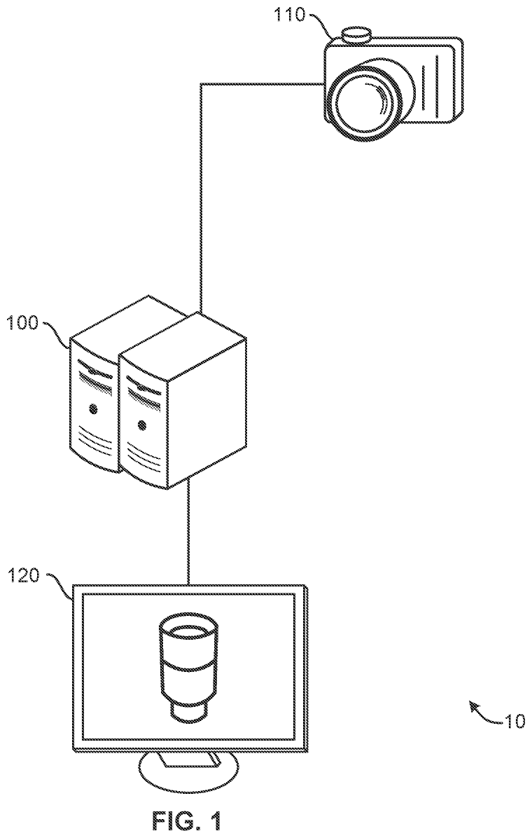

FIG. 1 shows a photo processing system 10. The photo processing system comprises an image capture device 110, a photo processing computing apparatus 100, and a display 120. In an example workflow one or more photographers using on or more image capture devices 10 acquire one or more images and then transfer the images to the photo processing apparatus 100. The photo processing apparatus contains instructions that cause it to estimate respective lighting conditions for the one or more images. Once the respective lighting conditions are estimated, photo processing adjustments are applied to each image based on the estimates of the lighting conditions. The resulting adjusted photos are shown to the user on the display 120.

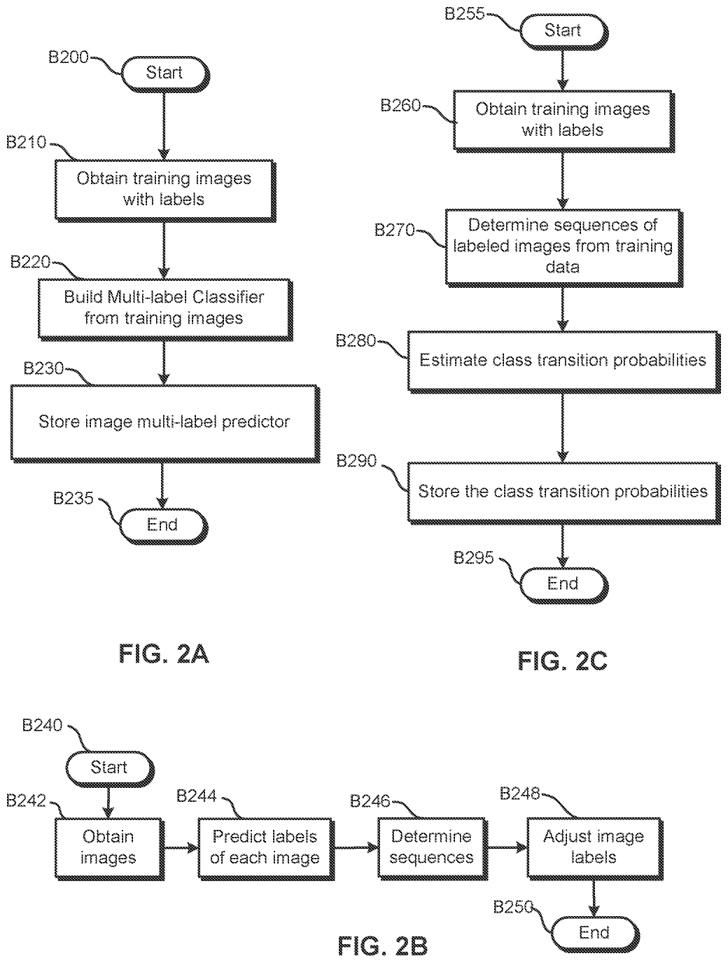

FIG. 2A shows an example embodiment of a lighting condition classifier training system. The flow starts in block B200 and continues to block B210 where the system obtains a set of training images with lighting condition labels. In this example embodiment, an image can be labeled with one or more labels such as “Soft Light”, “Hard Light”, “Backlit”, “High Dynamic Range”, “Tungsten”, “Tungsten Mix”, “Oversaturated”, and “Green Tint”. For example a photo of a person in a landscape setting of high variation of intensities with the sunlight behind them thereby creating a flare and low contrast on the subject's face may be labeled as both “High Dynamic Range” and “Backlit”. In some cases, a single label can be used. Moving to block B220, a multi-label classifier is constructed based on the labeled training images collected in B210. In some cases the classifier may be based on image features such as colors and dynamic range (histograms). In other cases the classifier may be a deep convolutional neural network. Once a classifier is trained the classifier predictor (the classifier process to perform prediction) is stored in block B230. The flow then ends in block B235.

In some embodiments the predictions from the classifier predictor are not the final predictions given to an image. In some cases, the predictions may be adjusted further based on an analysis of a sequence of photos captured. In other words, a photo's lighting condition prediction may be improved if the predictions from previous and subsequent photos are taken into consideration. Furthermore, the strength of the consideration for previous and subsequent photo predictions can also consider the amount of time that has elapsed between the photos.

FIG. 2B shows an example flow where a label prediction is enhanced by considering sequences of photos. The flow starts in block B240 and continues to block B242 where images to be processed are obtained. The flow continues to block B244 where the predictions are made based on the model developed in FIG. 2A for example. Flow then proceeds to block B246 where sequences of photos are determined. Example methods for determining sequences is described later. Next flow continues to block B248 where the labels of the photos are adjusted based on the asynchronous sequences. Embodiments for adjusting the labels are described later as well. Finally the flow ends in block B250. With the adjusted labels post-processing steps can be taken based on the adjusted predicted lighting conditions.

In order to consider the processing of the sequences of photos some embodiments estimate the transition probabilities from one lighting condition to another for a given period of time. FIG. 2C shows an example embodiment that is used to estimate lighting condition transition probabilities.

In FIG. 2C, the flow starts in block B255. Flow then moves to block B260 where training images with labels are obtained. Additionally, the images should have some associated metadata, such as, time image was captured, camera make, camera model, camera serial number, and lens used with camera, for example. Flow then moves to block B270 where the image is put into ordered sequences.

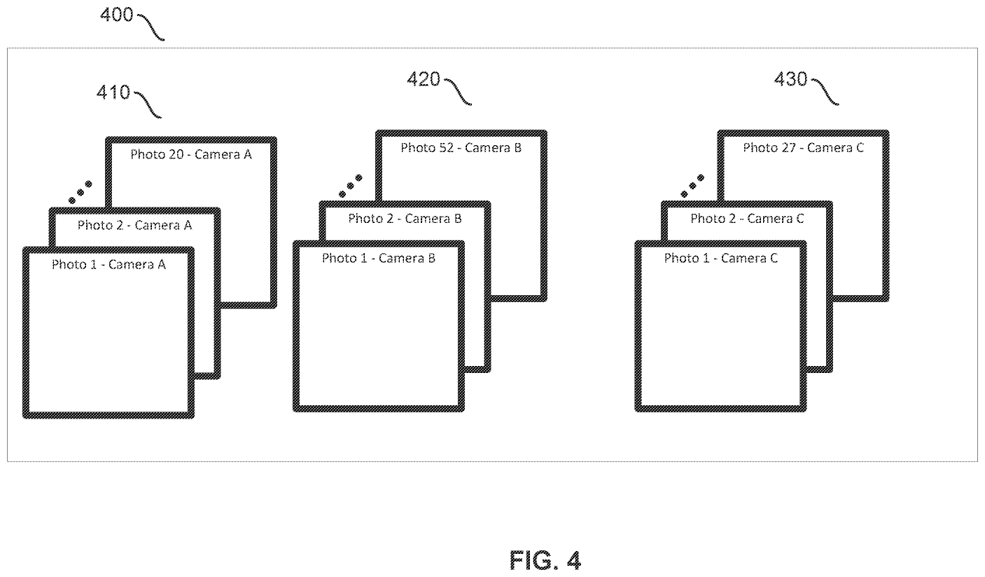

When photographs are processed, they may be from one or more sessions with one or more photographers. FIG. 4 shows an example of a collection of photographs 400 organized into three sequences: 410, 420, and 430. Each sequence itself is ordered by time from first to last taken.

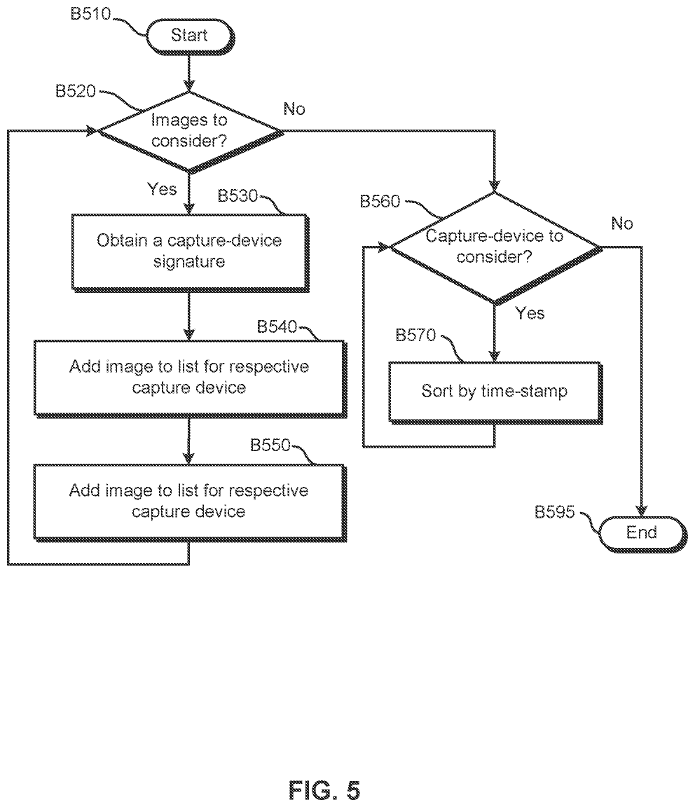

In FIG. 5, an example embodiment of a process for converting a collection of photos into a collection of sequences of photos is shown. The flow starts in block B510 and continues to block B520. In block B520 it is determined whether there are any photos in the collection of photos that still need to be put into a sequence set. If there are photos to be considered then flow continues to block B530 where a capture-device signature is obtained from the meta-data associated with the photo. For example, some images contain meta-data in the form of EXIF tags. These tags may include information about the make and model of the capture device used to capture the image. Some capture devices add EXIF information about the capture device serial number. Some capture devices may also provide information about the lens attached to the capture device or the focal length of the capture device used to acquire the image. In some cases this information may be provided separately or as part of the image filename. A combination of these items may be put together to identify a unique capture device configuration that should be treated as though they have some intrinsic relationship with one another. In one embodiment, the capture device make, model, serial number, and lens information are concatenated together to form a capture device-configuration signature. If one or more of these pieces of information are not available, the information may not be part of the uniquely identifying string. Some embodiments consider that a minimum amount of information must be available to consider a capture device a unique configuration. In some cases a uniquely identifying configuration string is not obtained and the decision is made to identify the capture device configuration as “unknown”. Flow continues to block B550 where the image is added to a list of images corresponding to its uniquely identifying configuration string. In the case of “unknown” capture devices, corresponding images are put into the “unknown” capture device image list.

Flow then continues back to block B520 where it is determined whether there are more images to consider to be assigned to their capture device configuration list. If it is determined that all images have been considered then flow moves to block B560. In block B560 the process starts to iterate through all of the identified capture device configurations. If there are capture device configurations left to process, flow continues to block B570 where all images in the capture device configuration image list are sorted by their capture timestamp. Capture timestamps may come from timestamps on the file, or through EXIF data or other meta-data associated with the file, for example. If a timestamp is not available for a particular image, a sentinel value is assigned to the timestamp to identify that the image is not associated with a time. Sometimes a timestamp representing a specific date in the past is used to indicate an image without a timestamp. Finally the images for the capture device configuration are sorted by timestamp from oldest to newest. Flow then continues to block B560 where it is determined whether there is another capture device configuration to consider. Finally in block B560 when all configurations have been processed and all of the configuration images have been sorted into chronological order, the flow continues to block B595 where the processing ends. In some embodiments this last processing loop sorts the images in the “unknown” configuration, but other embodiments don't sort the “unknown” configuration images.

Returning to FIG. 2C the determination of sequences of labeled images from training data of block B270 can be obtained by a process such as the example shown in FIG. 5. Once sequences are obtained, flow continues to block B280 where the transition probabilities from one lighting condition to another over time is estimated by finding transition probabilities from each lighting condition to every other lighting condition that best matches the observed sequences of data as identified in block B270.

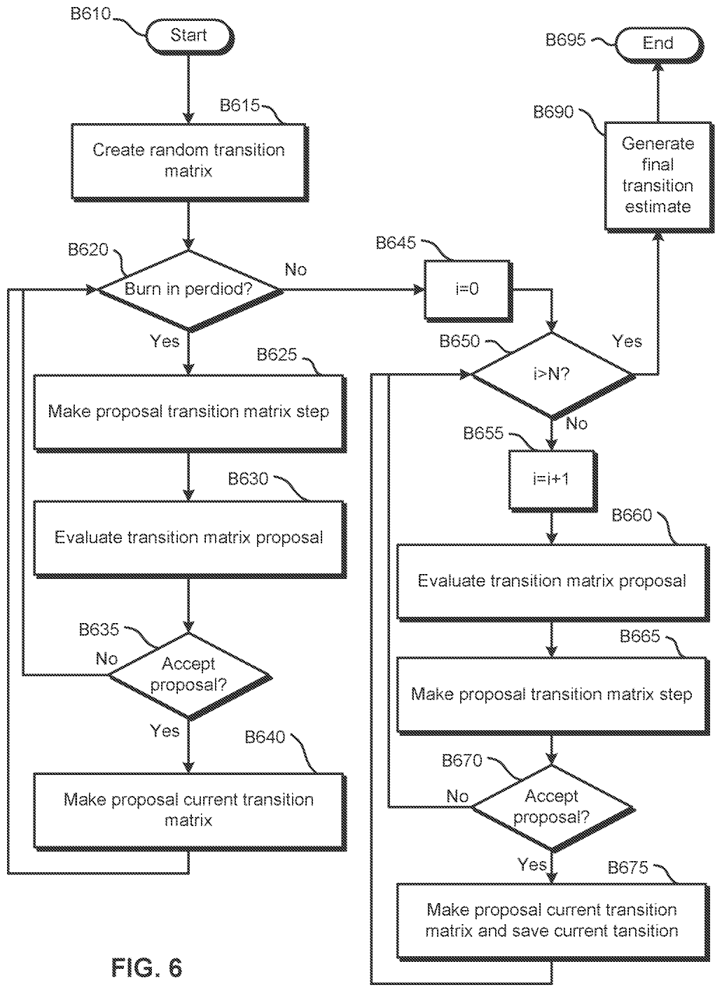

One example embodiment of the estimation of transition probabilities is outlined in FIG. 6. In FIG. 6, flow starts in block B610 and moves to block B615 where a random transition matrix is generated. There are several ways to create a random transition matrix. In some embodiments, the transition matrix is a stochastic matrix where the entries of the matrix are between 0 and 1 and the rows (or alternatively the columns) sum to 1. In other embodiments the transition matrix is constrained to be a double stochastic matrix where both the rows and columns sum to 1 and the entries are between 0 and 1.

In the case of the stochastic matrix, the matrix can be initialized with random numbers drawn from a uniform distribution between 0 and 1. Then the matrix rows (or alternatively columns) can be renormalized so that the rows (or columns) sum to one. The resulting matrix is a valid stochastic matrix. Some embodiments recognize that the final transition matrix will typically have a strong diagonal component. In other words, the diagonal entries in the stochastic matrix tend to be close to 1 and the off-diagonal elements tend to be close to zero. Thus in these embodiments, the matrix is first created by creating a matrix with uniform random entries between 0 and 1 and then adding a constant to the diagonal. Then normalization of the rows (or columns) is performed. For example if the value of 99 was added to the diagonal, the resulting matrix after normalization would be close to 0.99 on the diagonal entries and close to 0 on the off-diagonal entries.

In the case of a double stochastic matrix a similar approach may be followed. However this embodiment carries the modified normalization step of normalizing both rows and columns. One embodiment for normalizing a matrix to take on a double stochastic matrix form is to normalize the rows, then columns (or columns and then rows) and then repeated performing the row column normalizations until the matrix converges to a double stochastic matrix with rows and columns that both sum to 1.

These embodiments for matrix normalization can be used again in subsequent steps in this workflow.

Next the flow continues to block B620 where an iteration loop begins for a burn-in period. The exit criteria of the burn-in period may be defined as a fixed number of steps or based on a score relating to the convergence of the transition matrix estimate. If the loop has not reached its exit criteria then flow continues to block B625 where a proposal for a next transition matrix is made based on a random walk step taken from the current estimate. The proposal is based on a step generated by modifying the current transition matrix estimate through a random perturbation. The random perturbation may be generated by adding a zero mean normal random number with standard deviation of σ to each entry of the transition matrix. Resulting values that are below some small threshold ϵ or above 1−ϵ are rejected and re-sampled so that the effective resulting distribution added to each value is a truncated Gaussian. Once the matrix element perturbations are all found to be acceptable, the matrix is renormalized as was described previously in the discussion of block B615. The result is a valid stochastic or double stochastic matrix that has deviated slightly from the previous matrix.

The value of the standard deviation of the random normal perturbation, σ, may be defined as a iterative process (e.g. controlled by block B620 or B650), or may be defined dynamically based on certain acceptance criteria to ensure good progress in the random walk process (e.g. to ensure an approximate acceptance rate of blocks B625 and B670). In one embodiment the value of σ is given by σ=log(j+2), where j is the step number in the iteration controlled by B620 or B650. In other embodiments the value of a is decreased by a factor of F whenever a moving average of the acceptance rate of the proposal falls below a specified threshold. Of course many other strategies are possible.

Next the flow continues to block B630 where the transition matrix proposal is evaluated. Some embodiments score the transition matrix against sequences of observed data. For example, FIG. 5 describes how a collection of images maybe organized into time-ordered sequences for each capture device. One embodiment calculates the log-likelihood of each labeled sequence given the proposal transition matrix.

When calculating the log-likelihood some embodiments use the time interval between images to compute the probability of transitioning from a first label to a second label. If the transition matrix is represented by the matrix T and represents the transition probabilities in a single unit of time, then Tⁿ is the matrix representing the transition probability in n units of time, where Tⁿ is T to the n-th power (e.g. T³=T·T·T). Since many cameras provide timestamps in their EXIF data in units of 1 second resolution, some embodiments calculate T as the 1-second transition probabilities. If two consecutives images have a time difference of 3 seconds then the transition probability from label j to label k is the j-th row and k-th column of the matrix T³. In some cases, images from the same camera may have the same (valid) timestamp when taken in rapid succession such as a burst mode. Some embodiments treat the time between subsequent images to be the minimum of the actual time difference in seconds and 1 second (assuming the timestamp is valid, e.g. not missing and represented as a sentinel value). Some embodiments use different units of base time.

Some embodiments consider additional features to determine the “closeness” of two images in a sequence. In the above embodiment, the time difference determined the power of the transition matrix to arrive at a transition probability matrix for a given time period. Other embodiments consider image similarity as a measure of image “closeness”. For example, in some settings, such as a photo studio, lighting conditions can remain fairly static over time until the scene or lighting setup is rearranged. In cases like these, the transition probability is more related to the relative change in the image contents or image features rather than the actual time elapsed between photos.

One such embodiment uses a neural classifier trained to estimate lighting conditions and an image feature vector may be obtained from an intermediate layer of the classifier. When the network is used to estimate the lighting conditions it can also output the image feature vector. In a sequence of images the feature vectors can be compared via a distance or dissimilarity measure to estimate the image similarity from one image to the next in a sequence of images. A properly scaled measure can then be used in place of, or in conjuction with (e.g. in combination with) time to determine the “closeness” of images in a sequence. This measure can act as the exponent to the transition matrix in a similar fashion as we did with the time difference to provide transition probability estimates.

In some embodiments, the transition matrix can be simplified such that it is a single parameter double stochastic matrix: the transitions probabilities are the same to stay within any state and the probability of changing states is equally probable. In this case the K by K transition matrix takes on the form:

$$T = [ \begin{matrix}t & \frac{1 - t}{K - 1} & … \\ ⋮ & t & \\ ⋮ & & ⋱\end{matrix} ] = ( t - \frac{1 - t}{K - 1} ) {I}_{K} + ( \frac{1 - t}{K - 1} ) {𝕆}_{K}$$

where I_{K} is the identity matrix and [symbol] _{K} is a ones matrix and t is the probability of staying in a state when the closeness of the images is 1.0.

More generally we can define a balanced double stochastic matrix as:

T=aI_{K}+b [symbol] _{K}

We note that since each row and column must sum to one, a and b are related by:

$$a + b K = 1$$

$$Thus$$

$$b = \frac{1 - a}{K}$$

Then squaring the transition matrix T, we get

T²=(aI_{K}+b [symbol] _{K})²

T²=a²I_{K}+2ab [symbol] _{K}+b² [symbol] _{K}²

T²=a²I_{K}+(2ab+Kb²) [symbol] _{K}

Advantageously, the power of any matrix that can be described by aI_{K}+b [symbol] _{K} can also be decomposed with an a and b coefficient. This can be seen by the fact that the power involves the summation of only constant diagonal matrices or constant matrices:

$${T}^{p} = {\sum }_{n = 0}^{p} ( \begin{matrix}p \\ n\end{matrix} ) {a}^{n} {I}_{K} {b}^{p - n} {𝕆}_{K}^{p - n}$$

$${T}^{p} = ( {\sum }_{n = 0}^{p - 1} ( \begin{matrix}p \\ n\end{matrix} ) {a}^{n} {b}^{p - n} {K}^{p - n - 1} ) {𝕆}_{K} + {a}^{p} {I}_{k}$$

Moreover, and power of a double stochastic matrix is also double stochastic. Thus the b coefficient can be calculated based on the a coefficient and the transition matrix to any power can be describe as

$${T}^{p} = {a}^{p} {I}_{K} + \frac{1 - {a}^{p}}{K} {𝕆}_{K}$$

For the case of our transition matrix defined with parameter t,

$$a = t - \frac{1 - t}{K - 1}$$

This leads to a simplified transition matrix based on time and image similarity. We define a function based on two image Im1 and Im2 and the time between the images Δt:

δ=ƒ(Imᵢ,Imᵢ₊₁,tᵢ,iᵢ₊₁)

And the corresponding transition matrix is given by T^{δ}:

$${T}^{δ} = {( t - \frac{1 - t}{K - 1} )}^{δ} {I}_{K} + \frac{1 - {( t - \frac{1 - t}{K - 1} )}^{δ}}{K} {𝕆}_{K}$$

In one embodiment the function ƒ is calculated by:

ƒ(Imᵢ,Imᵢ₊₁,tᵢ,iᵢ₊₁)=w_{f}(1− [symbol] N(Imᵢ),N(Imᵢ₊₁) [symbol] )²+wₜ(tᵢ₊₁−tᵢ)

where N(Imᵢ) is the network feature of Imᵢ, [symbol] ⋅,⋅ [symbol] is an inner product, and w_{f} and wₜ are the feature and time difference weightings. Of course many other functions are possible considering these factors.

The log-likelihood is the log of the product of each transition probability across all sequences:

$$L ( T ) = log \{ {\prod }_{i = 1}^{M} [ {\prod }_{n = 2}^{{N}_{i}} ( {T}^{{t}_{{i}_{n}} - {t}_{{i}_{n - 1}}} ) {s}_{{i}_{n - 1}} , {s}_{{i}_{n}} ] \} = {\sum }_{i = 1}^{M} {\sum }_{n = 2}^{{N}_{i}} log ( {T}^{{t}_{{i}_{n}} - {t}_{{i}_{n - 1}}} ) {s}_{{i}_{n - 1}} , {s}_{{i}_{n}}$$

Where L(T) is the log-likelihood of transition matrix T, M is the number of labeled sequences ordered by time, tᵢ_{ₙ} is the timestamp in units of time of image n of sequence i, Nᵢ is the number of images in sequence i, and Sᵢ_{ₙ} is the label of image n of sequence i. The second form of the equation above written as a summation of log probabilities is used in some embodiments to avoid floating point underflow on the device processing the sequences since the product of many numbers between zero and one will underflow to zero for long sequences.

Block B630 evaluates the proposal based on the likelihood of the transition matrix. In one embodiment, a Metropolis-Hastings method is used to evaluate the ratio of the previous likelihood to the proposed likelihood. Alternatively, but equivalently, the difference of the log-likelihoods can be examined. The evaluation of the proposal in some embodiments results in a ratio of likelihoods or difference of log-likelihoods and the flow continues to block B635 where the system determines to accept the proposed transition matrix as the new current transition matrix.

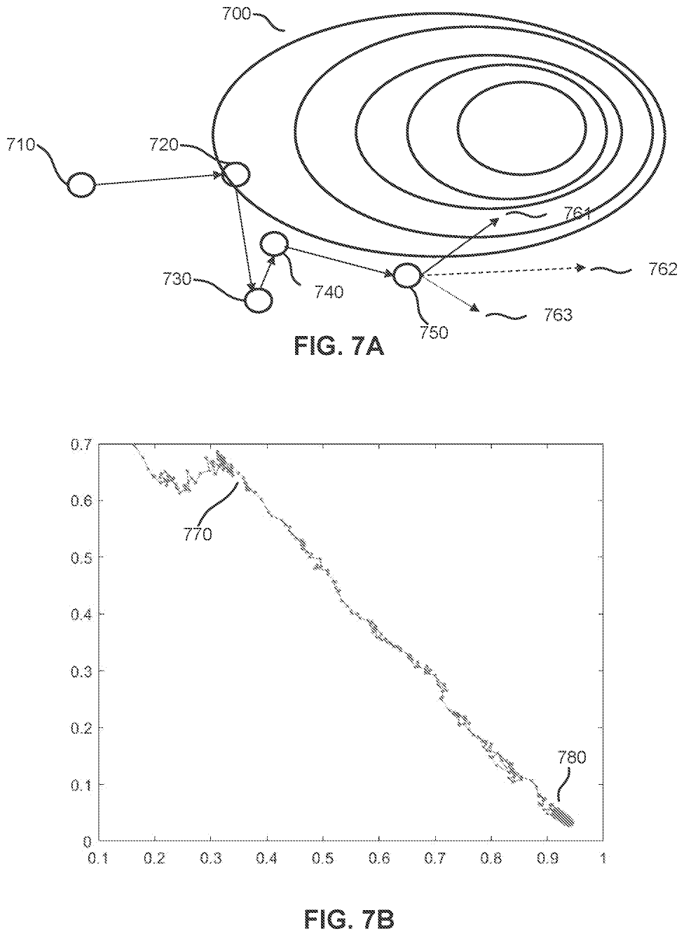

In block B635 the decision to accept the proposal can be further illustrated by FIG. 7A. In FIG. 7A the current transition estimate starts at location 710. The current transition then follows the progression to 720, 730, 740, and finally to position 750. At position 750 several proposals are possible for the next position. For example, the next proposed position could be position 761, 762, or 763. In FIG. 7A, the ellipses 700 denote the equivalent value lines of the likelihood function where the center of the ellipses represents a point of most likely transition values. Of course the transition matrix is represented by a matrix of multiple values and FIG. 7 merely represents two values or entries of this Matrix. In FIG. 7A, proposal 761 appears to increase the likelihood of the transition matrix given the sequence data. Proposal 762 causes likelihood to be slightly lower, and proposal 763 causes the likelihood to be significantly lower. Some embodiments make the acceptance of the proposal be always when the likelihood increases, slightly less likely when the likelihood slightly decreases, and very unlikely when the likelihood decreases significantly.

In some embodiments, when the ratio of proposal transition to current transition likelihoods is above 1.0 block B635 always accepts the proposal as the new current transition estimate. When the ratio is below 1.0, block B635 will randomly choose the proposal with a probability equal to the ratio. Once the determination whether to accept or reject a proposal the flow continues. In the case that a proposal is accepted, flow then proceeds to block B640 where the current transition matrix is made the proposal matrix. It is from this current transition that the next proposal will be generated from (e.g. as a perturbation of the current proposal).

If the proposal is not accepted in block B635 flow returns to block B620. If the proposal is accepted block B640 is done before the flow returns to block B620. In block B620 a check is performed to determine whether the burn in period has not ended. If the burn-in period has ended flow then passes to a second loop that is similar to the loop in blocks B620 through B640. In this second loop starting in block B645, the loop is run for a certain number of iterations and the accepted proposal are recorded in block B675. Once N iterations are performed as checked by block B650, the flow continues to block B690 where a final transition estimate is calculated. In some embodiments the final transition matrix is the transition matrix along the random walk carried out in blocks B620 to B675 which had the maximum likelihood score. In other embodiments the transition matrix is a normalized version of the average of all accepted proposal matrices encountered after the burn-in period. These are the matrices stored by block B675. Once a final transition estimate is generated, it is stored for further use in online prediction and flow continues to block B695 where the process terminates.

FIG. 7B illustrates and example of the estimation of a transition matrix as described in FIG. 6, for example. The graph of FIG. 7B shows the path of two entries (shown on horizontal and vertical axis) of the current transition matrix as proposals are accepted in the burn-in period 770 determined in blocks B620 through B640 of FIG. 6, and in the post-burn-in period 780 determined in blocks B645 through B675 of FIG. 6. After the burn-in period, the region 780 moves around the most likely solution and an estimate for the parameters can be taken as the maximum likelihood solution or a normalized average of the post-burn-in accepted proposals.

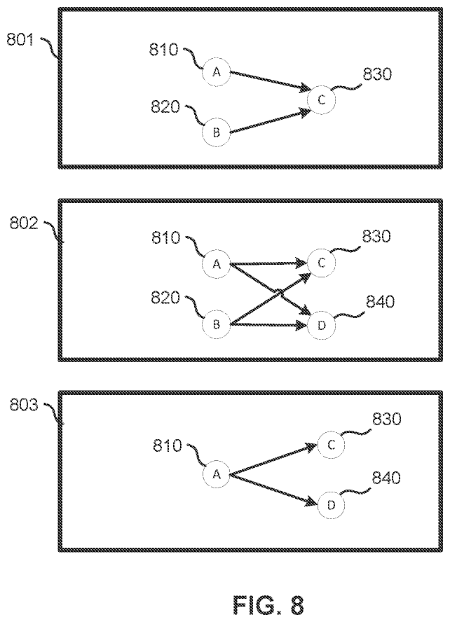

In some embodiments of FIG. 6 the labeled images can take on more than one label/state. For example, and image can be both “High Definition Range” and “Backlit”. In these cases further care can be taken when computing the likelihood probabilities of transitions since the image can transition from one or more first states to one or more second states. FIG. 8 illustrates some cases of state transition. In the first example 801, a sequence transitions from two labels, A 810 and B 820, to single label C 830. In this case the probability of this transition can be consider as follows: The probability of the initial state is 50% A 810 and 50% B 820. Thus given a sequence that spans t units of time, the t-unit transition matrix can be calculated as

U=T^{t}

Then if a is the index for label A 810, b is the index for label B 820, c is the index for label C 830 (and d the index of label D 840), then the transition likelihood for matrix T given a transition from labels A and B to label C in time t, is given by

$$L ( T \vert \{ A , B \} {\to }^{t} \{ C \} ) = 0.5 {U}_{a , c} + 0.5 {U}_{b , c}$$

In the example of 802 we similarly weigh the starting labels by the reciprocal of the number of starting labels and perform an “or” operation on the subsequent labels (probabilities add) to obtain:

$$L ( T \vert \{ A , B \} {\to }^{t} \{ C , D \} ) = 0.5 {U}_{a , c} + 0.5 {U}_{b , c} + 0.5 {U}_{a , d} + 0.5 {U}_{b , d}$$

And in the example shown in 803, there is a single starting label and multiple subsequent labels resulting in a likelihood of

$$L ( T \vert \{ A \} {\to }^{t} \{ C , D \} ) = {U}_{a , c} + {U}_{a , d}$$

More generally if the input set of labels is given by a set Q={q₁, q₂, . . . } and the cardinality of the set is denoted by |Q| and the subsequent label set is given by the set R={r₁, r₂, . . . } we can denote the likelihood of the transition over time t as:

$$L ( T \vert Q {\to }^{t} R ) = \frac{1}{\vert Q \vert} {\sum }_{q}^{Q} {\sum }_{r}^{R} {[ {T}^{t} ]}_{q , r}$$

In some embodiments the starting label and subsequent labels are randomly sampled from the sets Q and R when estimating the likelihood of the transition matrix. In these cases a method described previously may be used to calculate the likelihood.

Turning back to FIG. 2C, once the transition probabilities are estimated in block B280 (as is done in FIG. 6 for example), flow continues to block B290 where the transition probabilities are stored for later use. Next the flow proceeds to block 295 where the process of estimating the transition probabilities ends.

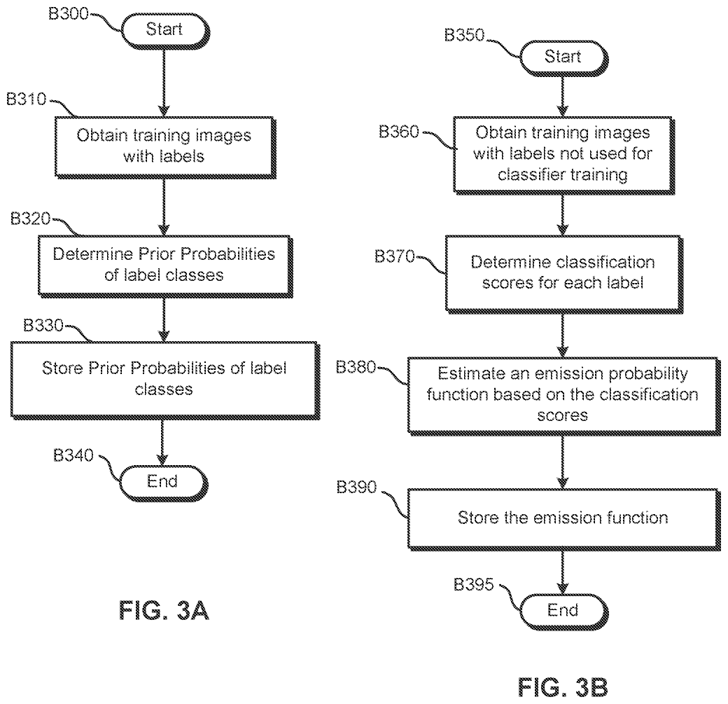

FIG. 3A shows an example embodiment for determining prior probabilities of labels. In this example, flow starts in block B300 and continues to block B310 where labeled training images are obtained. Flow proceeds to block B320 where the prior probabilities of the label classes is determined by counting the relative frequency of the labels as they occur in the training images. Then the prior probabilities are stored in block B330, and the flow terminates in block B340.

In some embodiments, the prior probabilities are considered to be all equal. Thus if there are K distinct labels then each label has a prior probability of 1/K. In this case block B310 is not needed. This embodiment may be useful when a label predictor such as a neural multi-label classifier is trained with an unbalanced dataset that is unbalanced similarly as the true prior distribution. Sometimes in these cases the classifier produces predictions that are biased towards the more frequent classes and these predictions essentially encapsulate the prior probabilities. Thus in some cases it is justifiable to use equal weighted prior probabilities for later use.

In FIG. 3B a flow for determining emission probability functions is described. Flow starts in block B350 and continues to block B360 where labeled training images are acquired. Typically the training images are not the training images used for the multi-label classifier because some classifiers tend to over-fit their training data. The emission probabilities are meant to capture the probability of a prediction given a true label. Flow continues to block B370 where the classification scores are obtained for each label. Then in block B380 the emission probability function given a classification score is estimated.

For block B380 several embodiments are possible. One embodiment determines the label from the classifier with the maximum score as the classifier output. In this case the probability of a true label given a predicted label is exactly the probability one would find in a confusion matrix generated from testing the classifier. Another embodiment may take each of the classifier's label scores and normalize them such that they sum to 1. In this case the probability of the true label can be estimated by the relative weight of the corresponding classifier's label score with respect to the other label scores. Some embodiments perform a soft-max operation on the prediction scores as the emission function. Other embodiments further try to characterize the distribution of scores generated by the classifier given a truth label. For example a mean and covariance matrix may be estimated for the classifier's label scores for all images labeled with each true label. Thus if there are K true labels, then there are K mean vectors and K covariance matrices. Thus the emission function returns a likelihood of a particular score by using a Gaussian formula. Some embodiments extend this function and represent it as a Gaussian Mixture Model. Of course other embodiments are possible, some of which are similar or extensions of the ones described here.

Flow continues to block B390 where the emission functions are saved for further use. Finally flow moves to block B395 where the process terminates.

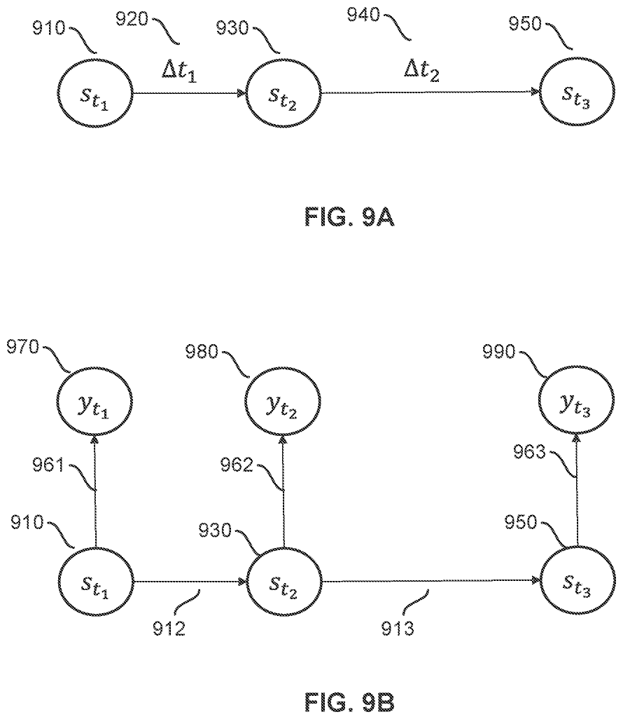

Turning to FIG. 9A a sequence of true labels for a capture device is shown. A first image label of sₜ_{₁} 910 occurs at time t₁, a second image with true label sₜ_{₂} 930 occurs at time t₂, and a third image of true label sₜ_{₃} 950 occurs at time t₃. Thus Δt₁ 920 is is the elapsed time between the image at t₁ and the image at t₂ calculated as (t₂−t₁) and θtₜ 940 is calculated as (t₃−t₂).

FIG. 9B expands on FIG. 9A to show the predictions yₜ_{₁} 970, yₜ_{₂} 980, and yₜ_{₃} 990. Arrows 961, 962, and 963 signify that the predictions of 970, 980, and 990 respectively are made on the images of the respective states 910, 930, and 950. This graph is a common representation of a Hidden Markov Model. The model is “Hidden” because the states or true labels are not observed directly but rather through a series of predictions/observations. The model is a “Markov” model because the state/label at any given time is only dependent on the state at the previous time.

Typically the goal when using a Hidden Markov Model is to attempt to estimate the hidden states (true labels) given observations. In the case described herein, the system estimates the true label given a set of prediction values. The values 970, 980, and 990 could be the label of the maximum prediction scores from a multi-label classifier or could be the set of scores for all labels from a classifier. Additionally it could be a feature vector derived from the image.

In FIG. 3B an emission function was estimated that provides an estimate equal or proportional to the probability of observing y given a true state s. Additionally in FIG. 2C, transition matrix probabilities were estimated that estimate the transition probability of moving along the graph of FIG. 9B: transition probability 912 of moving from sₜ_{₁} 910 to sₜ_{₂} 930 and the transition probability 913 of moving from sₜ_{₂} 930 to sₜ_{₃} 950. Additionally, in FIG. 3A. the prior probabilities were estimated that help determine the probability of being in state sₜ_{₁} 910 given no prior state in the sequence.

It can be seen that the example in FIG. 9B now contains the necessary probabilistic information to link 910, 970, 930, 980, 950, and 990. We can then use various algorithms to estimate the hidden states 910, 930, and 950. This estimation can be carried out by a variety of algorithms. For example the Viterbi algorithm can be used to find the most likely sequences of hidden labels. Alternatively, the forward-backward algorithm can be used to find the most likely hidden labels individually.

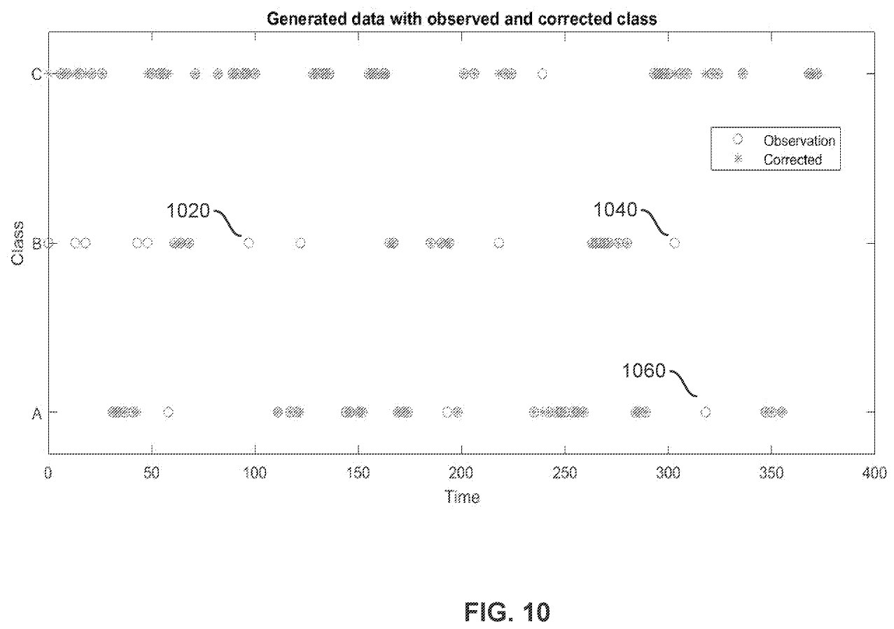

FIG. 10 illustrates a three label (A, B, C) asynchronous example where the Viterbi algorithm caused some of the corrected labels to deviate from some of the predicted/observed labels. The labels that were corrected tended to be outlier observations. For example, the observed labels 1020, 1040 and 1060 were all changed in a way that made their corrected labels more consistent with their local temporal neighbors. Label 1020 was changed from B to C, label 1040 was changed from B to C, and label 1060 was changed from A to C.

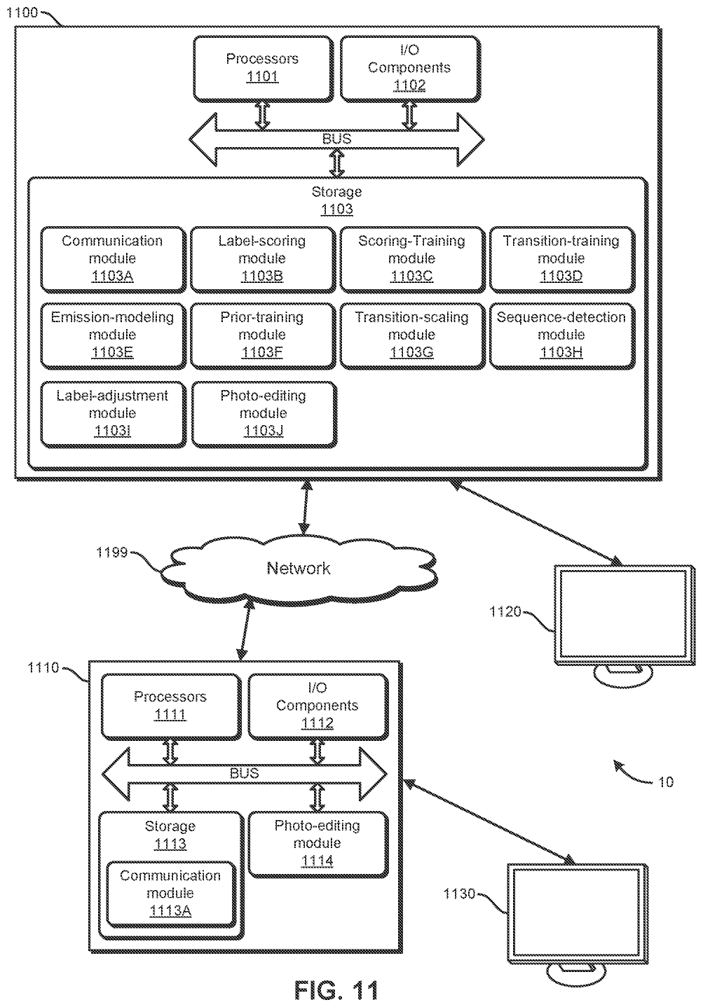

FIG. 11 illustrates an example embodiment of a system for image lighting condition detection. The system 11 includes a lighting-condition-detection device 1100, which is a specially-configured computing device; a photo-editing device 1110; and display devices 1120 and 1130. In this embodiment, the lighting-condition-detection device 1100 and the photo-editing device 1110 communicate via one or more networks 1199, which may include a wired network, a wireless network, a LAN, a WAN, a MAN, and a PAN. Also, in some embodiments the devices communicate via other wired or wireless channels.

The lighting-condition-detection device 1100 includes one or more processors 1101, one or more I/O components 1102, and storage 1103. Also, the hardware components of the lighting-condition-detection device 1100 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 1101 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 1102 include communication components (e.g., a graphics card, a network-interface controller) that communicate with the display device 1120, the network 1199, the photo-editing device 1110, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storage 1103 includes one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 1003, which may include both ROM and RAM, can store computer-readable data or computer-executable instructions.

The lighting-condition-detection device 1100 also includes a communication module 1103A, a label-scoring module 1103B, a scoring-training module 1103C, a transition-training module 1103D, an emission-modeling module 1103E, a prior-training module 1103F, a transition-scaling module 1103G, a sequence-detection module 1103H, a label-adjustment module 1103I, and a photo-editing module 1103J. A module includes logic, computer-readable data, or computer-executable instructions. In the embodiment shown in FIG. 11, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 1103. Also, in some embodiments, the lighting-condition-detection device 1100 includes additional or fewer modules, the modules are combined into fewer modules, or the modules are divided into more modules.

The label-scoring module 1103B includes operations programed to carry out label prediction such as those created through FIG. 2A and used in block B244 of FIG. 2B. The scoring-training module 1103C contains operations programed to carry out the functionality described in block B220 for FIG. 2A, for example. The transition-training module 1103D contains operations programmed to carry out transition matrix estimation such as the process described by FIG. 2C and further described in FIG. 6. The emission-modeling module 1103E contains operations programmed to carry out emission function modeling as described in FIG. 3B. The prior-training module 1103F contains operations programmed to estimate the prior probabilities of the labels as described in FIG. 3A. The transition-scaling module 1103G contains operations programmed to scale the transition matrix to an arbitrary time interval as described in blocks B630 and B660 of FIG. 6. The sequence-detection module 1103H contains operations programmed to detect sequences of images from various capture-devices as described in FIG. 5. The label-adjustment module 1103I contains operations programmed to adjust labels using algorithms such as the Viterbi algorithm or the forward-backward algorithm for Hidden Markov estimation, for example. The photo-editing module 1103J contains operations to edit a photo based in part on the lighting condition identified by the lighting-condition-detection device. In some embodiments the photo-editing module 1103J is omitted and is implemented as 1114 as part of the photo-editing as device 1110 which also includes one or more processors 1011, one or more I/O components 1112, storage 1113, a communication module 1113A. The communication module 1113A includes instructions that, when executed, or circuits that, when activated, cause the photo-editing device 1110 to capture an image, receive a request for an image from a requesting device, retrieve a requested image from the storage 1113, or send a retrieved image to the requesting device (e.g., the lighting-condition-detection device 1100). In some cases the photo editing device also contains similar instructions as found in 1103H and 1103I.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

We claim:

1. An apparatus for automatically adjusting a collection of images based on their lighting conditions comprising:
one or more processors; and
one or more memories storing instructions that, when executed, configure the one or more processors to:
obtain one or more images,
determine a first lighting condition scores for each lighting condition and for each of the one or more images using a trained prediction model; and
label the each of the one or more images based on the determined first lighting condition scores.

2. The apparatus of claim 1, wherein execution of the instructions further configures the one or more processors to:
obtain meta-data associated with each of the one or more images;
identify sequences of images in the one or more images;
generate lighting condition predictions based on a sequence analysis of the first lighting condition scores and the sequences of images and respective associated image meta-data; and
labeling the each or one or more image based on the lighting condition scores.

3. The apparatus of claim 2, wherein the sequence analysis is based, at least in part, on a time series analysis.

4. The apparatus of claim 2, wherein the sequence analysis is based, at least in part, on an image similarity analysis.

5. The apparatus of claim 2, wherein the sequence analysis further comprises the use of a single parameter transition matrix scaled exponentially by a closeness measure of the images in the sequence.

6. The apparatus of claim 1, wherein the trained prediction model is trained using training images labeled with lighting conditions depicted in the training images; and wherein the first lighting condition scores is based on the labeled lighting conditions in the trained model.

7. The apparatus of claim 1, wherein the trained prediction model is a multi-classifier trained prediction model having been trained using training images wherein each of the training images are labeled with lighting condition information and image feature information.

8. The apparatus of claim 1, wherein execution of the instructions further configures the one or more processors to:
generate a first lighting condition prediction based on the first lighting condition scores.

9. The apparatus of claim 8, wherein execution of the instructions further configures the one or more processors to:
identify and apply one or more image editing functions to the each of one or more images based on the predicted first lighting condition.

10. The apparatus of claim 1, wherein execution of the instructions further configures the one or more processors to:
identify and apply one or more image editing functions to the each of one or more images based on the first lighting condition scores.

11. A method of automatically adjust a collection of images based on their lighting conditions, comprising:
obtaining, by one or more processors, one or more images;
determining, by one or more processors, a first lighting condition scores for each lighting condition and for each of the one or more images using a trained prediction model; and
labeling, by one or more processors, the each of the one or more images based on the determined first lighting condition scores.

12. The method of claim 11, further comprising:
obtaining, by one or more processors, meta-data associated with each of the one or more images;
identifying, by one or more processors, sequences of images in the one or more images;
generating, by one or more processors, lighting condition predictions based on a sequence analysis of the first lighting condition scores and the sequences of images and respective associated image meta-data; and
labeling, by one or more processors, the each or one or more image based on the lighting condition scores.

13. The method of claim 12, wherein the sequence analysis is based, at least in part, on a time series analysis.

14. The method of claim 12, wherein the sequence analysis is based, at least in part, on an image similarity analysis.

15. The method of claim 12, wherein the sequence analysis further comprises using a single parameter transition matrix scaled exponentially by a closeness measure of the images in the sequence.

16. The method of claim 11, wherein the trained prediction model is trained using training images labeled with lighting conditions depicted in the training images; and wherein the first lighting condition scores is based on the labeled lighting conditions in the trained model.

17. The method of claim 11, wherein the trained prediction model is a multi-classifier trained prediction model having been trained using training images wherein each of the training images are labeled with lighting condition information and image feature information.

18. The method of claim 11, further comprising:
generating, by one or more processors, a first lighting condition prediction based on the first lighting condition scores.

19. The method of claim 18, further comprising:
identifying and applying one or more image editing functions to the each of one or more images based on the predicted first lighting condition.

20. The method of claim 11, further comprising:
identifying and applying one or more image editing functions to the each of one or more images based on the first lighting condition scores.
